(19) United States
(12) Patent Application Publication
(10) Pub. No.: US 2026/0061605 A1
(43) Pub. Date: Mar. 5, 2026

(54) CONFIGURING A VISUAL LANGUAGE MODEL WITH SPATIAL UNDERSTANDING FOR ROBOTICS

(71) Applicant: NVIDIA Corp., Santa Clara, CA (US)

(72) Inventors: Chan Hee Song, Columbus, OH (US); Valts Blukis, Seattle, WA (US); Jonathan Tremblay, Redmond, WA (US); Stephen Tyree, University City, MO (US); Stanley Thomas Birchfield, Sammamish, WA (US)

(73) Assignee: NVIDIA Corp., Santa Clara, CA (US)

(21) Appl. No.: 19/305,349

(22) Filed: Aug. 20, 2025

Related U.S. Application Data
(60) Provisional application No. 63/689,367, filed on Aug. 30, 2024.

(51) Int. Cl. B25J 9/16

(52) U.S. Cl. CPC B25J 9/163; B25J 9/1697

(57) ABSTRACT

Systems utilizing a vision-language model configured with a training dataset that includes images labeled with spatial question-and-answer pairs, the question-and-answer pairs encoding object-to-object relationships and object-to-space relationships depicted in the images, and at least one data processor configured to operate the vision-language model to carry out a robotic task.

### CROSS-REFERENCE TO RELATED APPLICATIONS

This application claims priority and benefit under 35 U.S.C. 119(e) to U.S. application Ser. No. 63/689,367, filed on Aug. 30, 2024, “Data Generation for Teaching Spatial Understanding to VLMs for Robotics”, the contents of which are incorporated herein by reference in their entirety.

### BACKGROUND

Large language models (LLMs) based on deep learning neural networks have demonstrated the ability to learn the steps involved in various tasks. Large language models may be applied to generate robotic task plans having the form of step-by-step instructions, program code, and cost-maps. Large language models may therefore contribute to the development of robots with an understanding of unstructured scenes comprising unseen objects and complex semantics.

Some conventional applications of large language models for robotic task planning assume the pre-existence of a set of low-level skills along with well-defined interface through which the large language model interacts with these skills. Implementing such skills is a challenging problem that is difficult to implement in practice, especially if the goal is robotic operation in unstructured and previously unseen environments.

Some conventional applications of large language models for robotic task planning configure the large language model to specify reward functions that define the low-level skills via motion optimization or reinforcement learning. These approaches may assume near-perfect perception and a textual scene representation language that is sufficiently detailed for the large language model to generate robot behavior, which may not be feasible in practice.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an example of a robotic system and task environment.

FIG. 2 depicts an example of points identified by a vision-language model in response to a question “Return points that are in front of the picture”.

FIG. 3 depicts a taxonomy of six question types in accordance with one embodiment.

FIG. 4 depicts a robotic system in accordance with one embodiment.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

### DETAILED DESCRIPTION

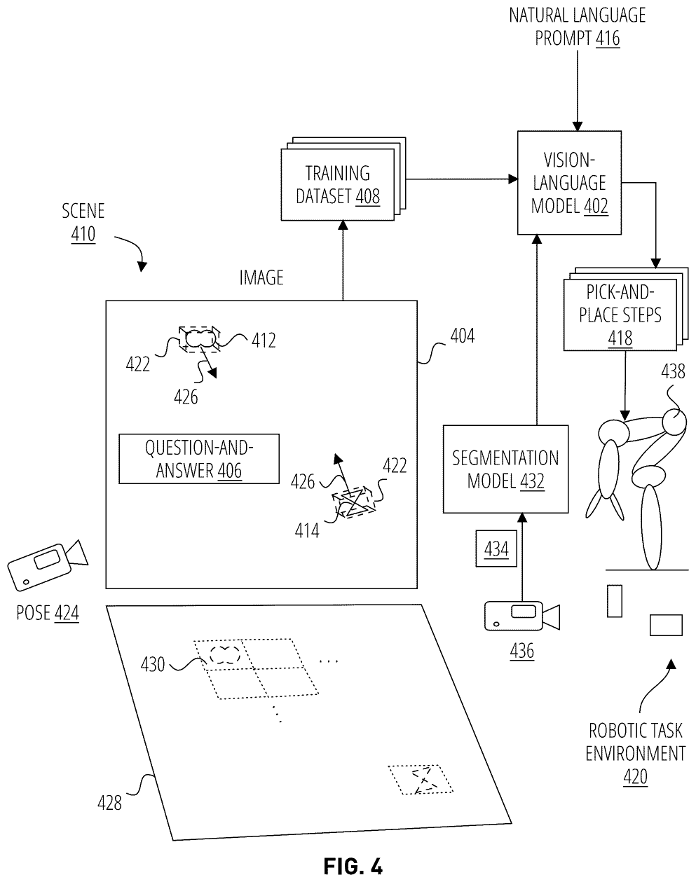

Disclosed herein are embodiments of vision-language models 402 (FIG. 4) configured (trained) on images 404 tagged with spatial question-and-answer 406 text. A training dataset 408 and benchmark for a vision-language model utilized for robotic tasks may be configured from multiple annotated scenes 410 and conventional image datasets annotated with spatial question-and-answer 406 tuples. Images 404 may be oriented to multiple reference frames. The question-and-answer 406 text may encode inter-object relationships (object-object relations) between an anchor object 412 and a second object 414, object-spatial relationships (object-space relations), and grounding clues for objects depicted in the images 404. A grounding clue makes reference to at least one object, and may comprise an indication of or question about a parent object to which a child object belongs (e.g., a button on a blender, a handle on a drawer).

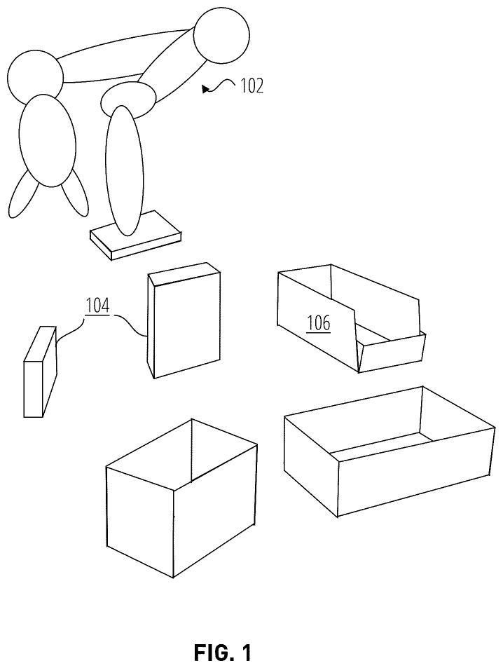

Vision-language models configured using the disclosed mechanisms may demonstrate an improved ability over conventional mechanisms to transform natural language prompts 416 comprising instructions for object rearrangement and household tasks into pick-and-place steps 418 for robotic action. FIG. 1 and FIG. 4 depict examples of robotic systems and robotic task environments 420 into which the disclosed mechanisms may be deployed. An example of a natural language prompt 416 to the robotic system 102 in FIG. 1 or FIG. 4 might be “Place the boxed food items in the leftmost container.” (Boxed food items 104 and container 106).

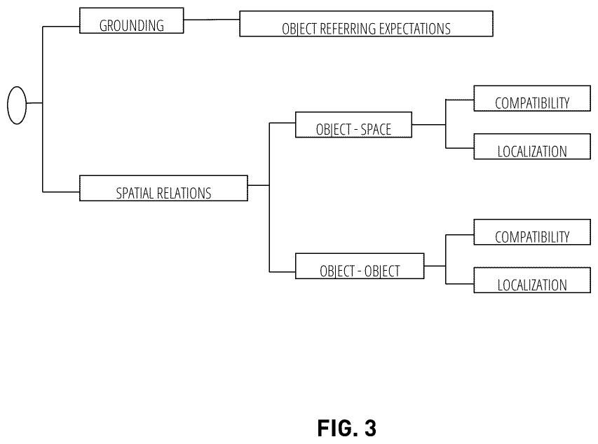

In one embodiment a taxonomy of six question types is utilized (see FIG. 3). For each question type, mechanisms are implemented to generate the questions and corresponding answers from 3D bounding box annotations 422 made to the images 404. The questions may invoke the vision-language model's understanding of spatial relations between objects and between objects and free (unoccupied) space, with the answers comprising true responses for purposes of tuning hyperparameters of the vision-language model 402 during training.

Some of the questions may have answers which are numeric. Question-and-answer 406 pairs are formulated to train the vision-language model 402 with a spatial understanding for planning robotic tasks. For example, a question-and-answer 406 pair (tuple) may encode instructions for whether or not the task “keep away the mug” may be carried out with a single pick-and-place step 418, or with multiple pick-and-place steps 418 to resolve constraints such as moving blocking objects out of the way.

An example question-and-answer pair that may be generated is:
Question: Examine the image of the stacked items on the table. If you were to remove the box of “Granola Bars” from the arrangement, which item(s) would directly fall or be affected?
Answer: If the “Granola Bars” box is removed, the “Cookies” box, which is leaning against it, would likely fall or be affected.

Another example of a generated question-and-answer pair is:
Question: Observe the image carefully. If you were to move the hamburger directly to the right, which object would it be closest to?
Answer: If you move the hamburger directly to the right, it would be closest to the pink bowl.

Questions with numeric answers may be configured to orient the vision-language model 402 in a world or modular reference frame of the robotic system 102. For example, the answer to a question “where should I keep the mug on the top shelf?” may be the numeric coordinate of a world location provided as an input to a robot pick-and-place task.

In one embodiment, each question-and-answer 406 tuple may be configured in one of three different reference frames:
1. Ego-centric-from the perspective of an observer positioned at a camera pose 424 position;
2. Object-centric-from the perspective of a reference frame of an object of the instruction;
3. Allo-centric-from the perspective of a world (task environment) reference frame.

An example of an object-centric question-and-answer 406 pair may be:
Question: Is the chair in front of the desk?
Answer: Yes

An example of an ego-centric question-and-answer 406 pair may be:
Question: Is the chair in front of the window?
Answer: Yes

Each question may specify the reference frame in which it is to be interpreted, or leave inference of the reference frame to the vision-language model 402 based on the context of the question or other factors.

Training datasets 408 for the vision-language model 402 may be generated by input of a scene dataset D comprising multiple views, for example each formatted as red-green-blue (RGB) pixelated images 404 with depth RGB(Depth). The scene dataset may further comprise camera poses 424 and object annotations 422, 406 formatted as text labels and oriented 3D bounding boxes on the images 404.

The dataset D may comprise elements dᵢ wherein each element dᵢ=(Iᵢ, qᵢ, aᵢ, lᵢ) comprises an image Iᵢ, a text-formatted question qᵢ, a text-formatted answer aᵢ to the question, and a reference frame label lᵢ∈{allo, object, ego}.

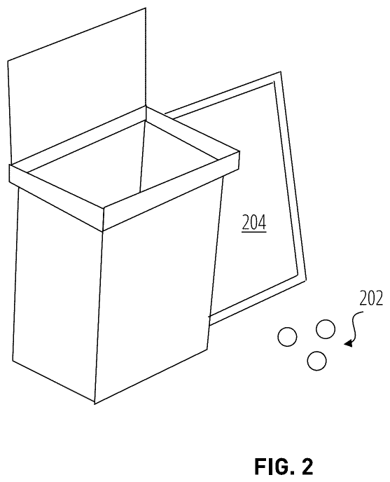

Spatial relationships between objects in the dataset D may be determined to satisfy one or more of “left”, “right”, “in front”, “behind”, “above”, and “below”. FIG. 2 depicts an example of points 202 identified by the vision-language model 402 in response to a question “Return points that are in front of the picture”. (object 204). In one embodiment, each question may be classified into the taxonomy depicted in FIG. 3 (two types of grounding questions, two types of object-to-space relationship questions, and two types of object-to-object relationship questions).

Examples of object-to-object relationships include relative positions of two objects (e.g. left of, right of, above, below) and spatial compatibility (e.g., will an object fit into another object?)

A two-stage process may be implemented comprising spatial relation extraction (stage 1) and automated question-and-answer generation based on the extracted spatial relations (stage 2).

In the spatial relation extraction stage, a set of spatial relations between objects or between objects and points in free space are extracted from the dataset D.

Examples of object-to-space relationships include relative positions of objects and points in space (e.g. left of, right of, above, below) and spatial compatibility (e.g., will an object fit into a spatial location?)

Each spatial relation may be expressed as (Iᵢ, aᵢ, tᵢ, sᵢ, rᵢ, lᵢ), where Iᵢ is an image, aᵢ is an anchor object, tᵢ is a target object or a target free-space point, sᵢ is size measure based on an object to be manipulated, rᵢ∈{left, right, above, below, front, behind} is a spatial relation, and lᵢ∈{allo, object, ego} is a reference frame label.

Oriented 3D bounding box annotations 422 may be applied to the images 404 to enable the automatic generation of spatial relationships in stage 1. The 3D bounding box annotations 422 may comprise information about the orientation of objects they enclose (i.e., the facing direction 426 of the object) and the object's 3D location in the scene 410. A heuristic may be applied to automatically extract spatial relationships between objects and between objects and points in space.

The question and answer generation process may be fully automated based on a rule-based template system. Once spatial relations are extracted from the 3D bounding boxes, including anchor and target objects, spatial relation types such as “left of” or “in front of,” and the applicable reference frame, the system may convert these relations into natural language questions using deterministic templates.

Each type of spatial relation may be associated with a predefined question format. For example:
For spatial configuration: “Is the [target] [relation] the [anchor] ([reference frame] frame)?”
For spatial compatibility: “Can the [target] fit [relation] the [anchor] ([reference frame] frame)?”
For spatial context (object to space): “Point to empty space [relation] the [anchor] ([reference frame] frame).”
For object grounding: “Find all instances of [object NAME].”

Object names may be derived directly from semantic labels provided in the original 3D scene annotations. Answers to the questions may be derived from the spatial computations in the question generation stage. Configuration and compatibility questions may produce binary answers such as “Yes” or “No.” Context questions may return a list of 2D pixel coordinates that indicate valid empty-space locations. Object grounding questions may return a list of 2D bounding boxes corresponding to all visible instances of the specified object in the image.

A mechanism such as this may enable the entire pipeline from annotated 3D to question and answer pairs to be automatic and reproducible. Manual writing or labeling of questions or answers may be obviated.

Some robotic tasks may involve the vision-language model 402 determining a spatial relationship (object-space relation) between points (e.g., x, y coordinates in a particular reference frame) and an object, herein the “anchor object 412”. One example of such a relationship is identifying points 202 that are in front of another object 204, for example as depicted in FIG. 2.

A map of a robotic task environment 420 may be generated from the annotated 3D bounding box annotations 422 and randomly sampled points in empty areas that are a set distance from an object of a task. The set distance may be based on the size of another object that is to be manipulated and placed in relation to the object.

For each of the three reference frames, a direction indicated by a spatial relation may be selected. For example, if the spatial relations is [object reference frame, in front], only the points that are in a forward direction from (in front of) the oriented bounding box are selected.

The automatic generation of object-to-object relationships may follow a similar process as does the automatic generation of object-to-space relationships. However, for generation of object-to-object relationships, instead of selecting points, an object may be selected that is in a certain spatial direction from the anchor object 412. To avoid ambiguity, selection may be restricted to objects that appear only once in a given reference frame. Object-to-object relationships may be generated between all object pairs in a particular reference frame.

One implementation of spatial relation extraction is based on discovering relationships in a particular (e.g., Cartesian) coordinate space. In this implementation, a reference frame is selected, such as an ego-centric camera reference frame, a world reference frame associated with a scene, or an object centric reference frame based on a particular object. Applying the selected reference frame, multiple categories of spatial relations are extracted from the bounding-box annotated image 404.

One such category of spatial relationships is positional. The category of positional relationships includes horizontal, vertical, and depth relationships, which determine whether one object is to the left, right, above, below, in front of, behind, or overlapping with another object.

One mechanism for extracting positional relationships between objects compares the minimum and maximum coordinates of the 3D bounding box annotations 422 for the objects along a relevant axis. For horizontal relationships, the x-coordinates of the 3D bounding box annotations 422 may be compared. For vertical relationships, the z-coordinates of the 3D bounding box annotation 422 may be compared. For depth relationships, the y-coordinates of the 3D bounding box annotation 422 may be compared.

If all coordinates of the first box are less than those of the second box along the relevant axis, the first object is to the left, below, or in front of the second object. If all coordinates of the first box are greater than those of the second box along the relevant axis, the first object is to the right, above, or behind the second object. Otherwise, the boxes are overlapping.

Another mechanism for extracting positional relationships between objects utilizes center points of the 3D bounding box annotation 422. For horizontal relationships, the x-coordinates of the center points may be compared. For vertical relationships, the z-coordinates of the center points may be compared. For depth relationships, the y-coordinates of the center points may be compared. If the center of the first object's box is to the left, below, or in front of the second object's box and not inside it, the first object's box is to the left, below, or in front of the second object's box. If the center of the first object's box is to the right, above, or behind the second object's box and not inside it, the first object's box is to the right, above, or behind the second object's box. Otherwise, the boxes are overlapping.

Another type of positional relationship between objects is based on the relative position of one object with respect to another object's orientation (e.g., as determined by a facing direction 426). The facing direction 426 of an object may be determined from the rotation matrix (e.g., quaternion) of the 3D bounding box annotation 422. The relative position of the object with respect to a second object may be applied using the dot product and cross product of their positions and facing directions 426. If the dot product is positive, the first object is in front of the second object. If the dot product is negative, the first object is behind the second object. If the cross product's z-component is positive, the first object is to the left of the second object. If the cross product's z-component is negative, the first object is to the right of the second object. A check may also be performed to determine if the objects overlap in any of the x, y, and z dimensions.

A spatial compatibility relationship between objects determines if one object can fit in specific positions relative to another object. To evaluate spatial compatibility, the bounding box dimensions of the two objects may be compared. If the top box's x and y dimensions are less than or equal to the base box's x and y dimensions, the top box may fit on top of the base box.

A grid-based mechanism may be applied to check if the first object can fit in specified positions (left, right, in front, behind) relative to the second object. The bounding boxes of the two objects may be projected to a plane, e.g., a floor plane 428. “Floor plane” refers to a plane horizontal to an image plane and positioned at or below a lowest vertical or height coordinate of the image plane. A grid structure 430 imposed on the floor plane 428 may be marked with areas occupied by objects. If the first object can fit in the empty areas of the grid in the specified positions, the objects may be assigned spatial compatibility.

Question-and-answer tuples may be constructed by applying the relationships generated using these mechanisms. The question-and-answer tuples may be applied to configure the vision-language model 402 to reason with vision rather than relying on language understanding alone. The question-and-answer tuples may be structured using templates.

A template that may be utilized for this purpose has the structure:
object, spatial relationship, anchor object
where the spatial relationship is one of the six defined relations described previously.

The constructed configuration dataset for the vision-language model 402 may comprise a balanced set of spatial relationship types to avoid introducing bias into the model.

A vision-language model 402 configured using the disclosed mechanisms may be integrated into robotic controls systems. For modular systems, a segmentation model 432 (e.g., Segment Anything Model vs, “SAM2”) may be operated to segment all objects in a scene depicted in an image 434 of the robotic task environment 420 captured by a camera 436. The vision-language model 402 may be prompted to identify which objects are reasonable for the robot 438 to manipulate, yielding a subset of candidate objects, each with an associated string identifier. The vision-language model 402 may then be provided with a natural language prompt 416 to generate pick-and-place steps 418 for the task at hand. In one embodiment these steps may take the form of Python code.

Each generated pick-and-place step 418 may be parameterized by either an object ID or a coordinate relative to the object to identify free-space locations. Within a modular system, the vision-language model 402 may observe objects in isolation, or observe a text summary of the scene. In modular systems the vision-language model 402 may not observe or reason about the entire scene from a single image 434.

In a grounded system, the image 434 of the entire robotic task environment 420 may be input to the vision-language model 402 along with an instruction. The natural language prompt 416 may cause the vision-language model 402 to decompose the instruction into a series of pick-and-place steps 418 parameterized by two-dimensional coordinates. The vision-language model 402 may query itself with follow-up questions to aid its reasoning. For example, the vision-language model 402 may prompt itself about whether certain actions are feasible in the scene depicted in the image 434. An example question-and-answer sequence that the vision-language model 402 may generate is:
Question 1: Is the milk left of orange juice?
Answer: No
Question 2: Is the pineapple can above the milk?
Answer: No
Question 3: Is granola bar occluded?
Answer: Yes

Within a grounded system, the vision-language model 402 may directly observe the overall robotic task environment 420 and reason about spatial relationships and spatial compatibility between objects in order to find a solution to the step.

The mechanisms disclosed herein may be implemented in and/or by computing devices and/or robots utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary systems will now be described that may be configured to implement the mechanisms disclosed herein for robotic task control, e.g., as machine-readable instructions configuring a non-volatile memory (e.g., memory 502, main memory 1002) thereby configuring one or more data processors to control a robot.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar”refers to a “crossbar”.

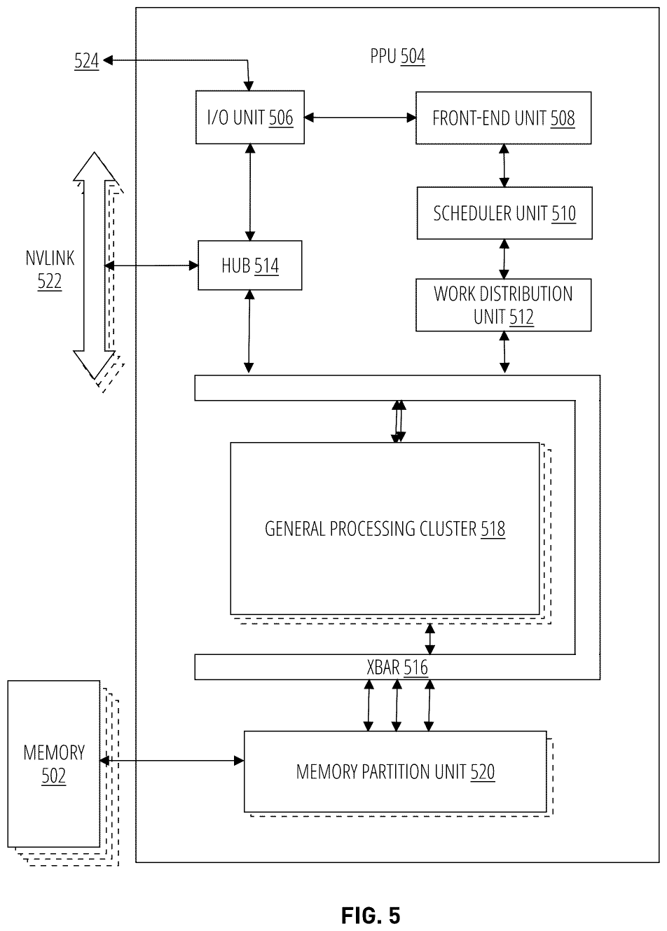

FIG. 5 depicts a parallel processing unit 504, in accordance with an embodiment. In an embodiment, the parallel processing unit 504 is a multi-threaded processor that is implemented on one or more integrated circuit devices. The parallel processing unit 504 is a latency hiding architecture designed to process many threads in parallel. A thread (e.g., a thread of execution) is an instantiation of a set of instructions configured to be executed by the parallel processing unit 504. In an embodiment, the parallel processing unit 504 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 504 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 504 modules may be configured to accelerate thousands of High Performance Computing (HPC), data center, and machine learning applications. The parallel processing unit 504 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 504 includes an I/O unit 506, a front-end unit 508, a scheduler unit 510, a work distribution unit 512, a hub 514, a crossbar 516, one or more general processing cluster 518 modules, and one or more memory partition unit 520 modules. The parallel processing unit 504 may be connected to a host processor or other parallel processing unit 504 modules via one or more high-speed NVLink 522 interconnects. The parallel processing unit 504 may be connected to a host processor or other peripheral devices via an interconnect 524. The parallel processing unit 504 may also be connected to a local memory comprising a number of memory 502 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 502 may comprise logic to configure the parallel processing unit 504 to carry out aspects of the techniques disclosed herein.

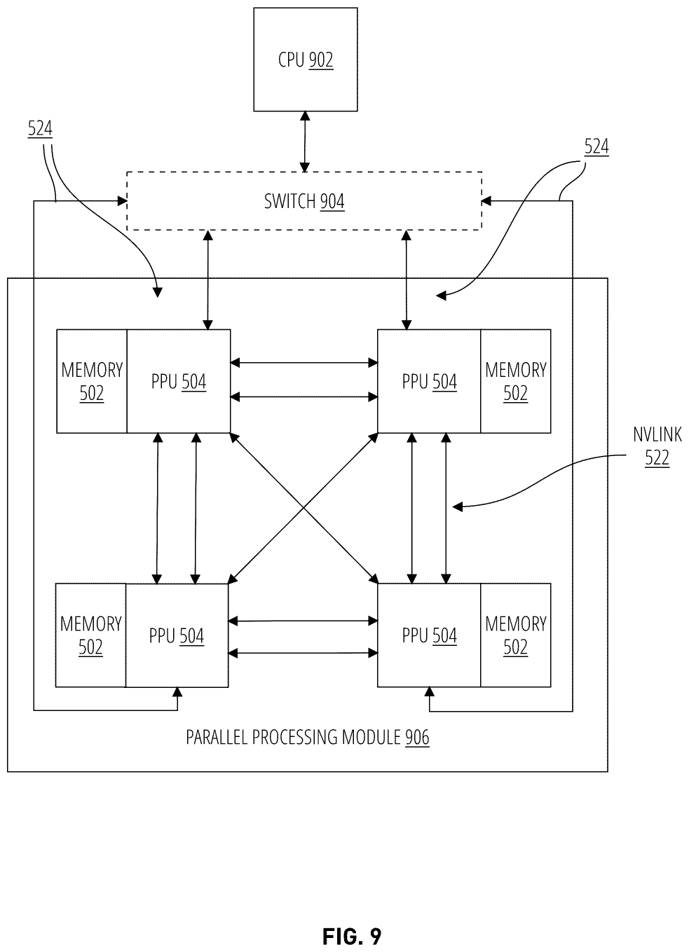

The NVLink 522 interconnect enables systems to scale and include one or more parallel processing unit 504 modules combined with one or more CPUs, supports cache coherence between the parallel processing unit 504 modules and CPUs, and CPU mastering. Data and/or commands may be transmitted by the NVLink 522 through the hub 514 to/from other units of the parallel processing unit 504 such as one or more copy engines, a video encoder, a video decoder, a power management unit, etc. (not explicitly shown). The NVLink 522 is described in more detail in conjunction with FIG. 9.

The I/O unit 506 is configured to transmit and receive communications (e.g., commands, data, etc.) from a host processor (not shown) over the interconnect 524. The I/O unit 506 may communicate with the host processor directly via the interconnect 524 or through one or more intermediate devices such as a memory bridge. In an embodiment, the I/O unit 506 may communicate with one or more other processors, such as one or more parallel processing unit 504 modules via the interconnect 524. In an embodiment, the I/O unit 506 implements a Peripheral Component Interconnect Express (PCIe) interface for communications over a PCIe bus and the interconnect 524 is a PCIe bus. In alternative embodiments, the I/O unit 506 may implement other types of well-known interfaces for communicating with external devices.

The I/O unit 506 decodes packets received via the interconnect 524. In an embodiment, the packets represent commands configured to cause the parallel processing unit 504 to perform various operations. The I/O unit 506 transmits the decoded commands to various other units of the parallel processing unit 504 as the commands may specify. For example, some commands may be transmitted to the front-end unit 508. Other commands may be transmitted to the hub 514 or other units of the parallel processing unit 504 such as one or more copy engines, a video encoder, a video decoder, a power management unit, etc. (not explicitly shown). In other words, the I/O unit 506 is configured to route communications between and among the various logical units of the parallel processing unit 504.

In an embodiment, a program executed by the host processor encodes a command stream in a buffer that provides workloads to the parallel processing unit 504 for processing. A workload may comprise several instructions and data to be processed by those instructions. The buffer is a region in a memory that is accessible (e.g., read/write) by both the host processor and the parallel processing unit 504. For example, the I/O unit 506 may be configured to access the buffer in a system memory connected to the interconnect 524 via memory requests transmitted over the interconnect 524. In an embodiment, the host processor writes the command stream to the buffer and then transmits a pointer to the start of the command stream to the parallel processing unit 504. The front-end unit 508 receives pointers to one or more command streams. The front-end unit 508 manages the one or more streams, reading commands from the streams and forwarding commands to the various units of the parallel processing unit 504.

The front-end unit 508 is coupled to a scheduler unit 510 that configures the various general processing cluster 518 modules to process tasks defined by the one or more streams. The scheduler unit 510 is configured to track state information related to the various tasks managed by the scheduler unit 510. The state may indicate which general processing cluster 518 a task is assigned to, whether the task is active or inactive, a priority level associated with the task, and so forth. The scheduler unit 510 manages the execution of a plurality of tasks on the one or more general processing cluster 518 modules.

The scheduler unit 510 is coupled to a work distribution unit 512 that is configured to dispatch tasks for execution on the general processing cluster 518 modules. The work distribution unit 512 may track a number of scheduled tasks received from the scheduler unit 510. In an embodiment, the work distribution unit 512 manages a pending task pool and an active task pool for each of the general processing cluster 518 modules. The pending task pool may comprise a number of slots (e.g., 32 slots) that contain tasks assigned to be processed by a particular general processing cluster 518. The active task pool may comprise a number of slots (e.g., 4 slots) for tasks that are actively being processed by the general processing cluster 518 modules. As a general processing cluster 518 finishes the execution of a task, that task is evicted from the active task pool for the general processing cluster 518 and one of the other tasks from the pending task pool is selected and scheduled for execution on the general processing cluster 518. If an active task has been idle on the general processing cluster 518, such as while waiting for a data dependency to be resolved, then the active task may be evicted from the general processing cluster 518 and returned to the pending task pool while another task in the pending task pool is selected and scheduled for execution on the general processing cluster 518.

The work distribution unit 512 communicates with the one or more general processing cluster 518 modules via crossbar 516. The crossbar 516 is an interconnect network that couples many of the units of the parallel processing unit 504 to other units of the parallel processing unit 504. For example, the crossbar 516 may be configured to couple the work distribution unit 512 to a particular general processing cluster 518. Although not shown explicitly, one or more other units of the parallel processing unit 504 may also be connected to the crossbar 516 via the hub 514.

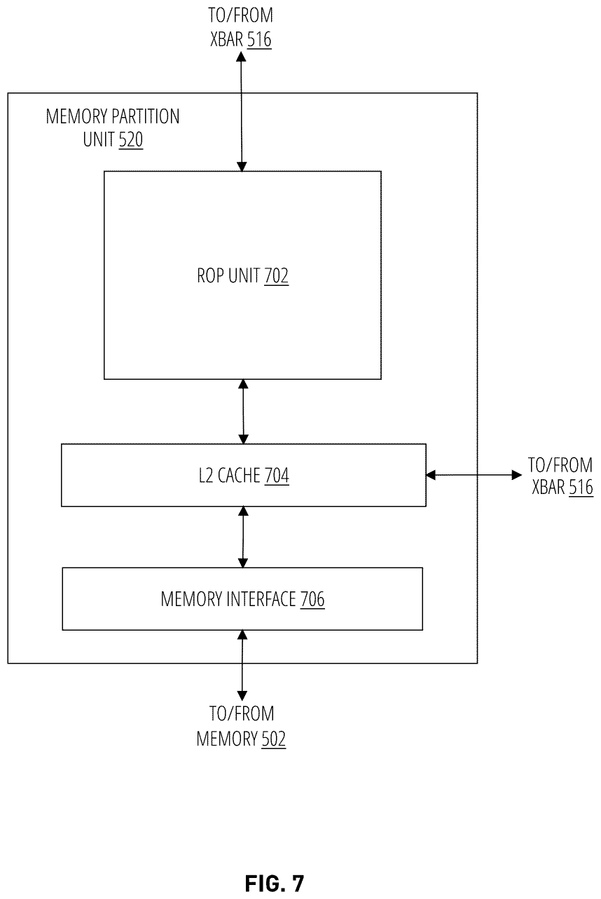

The tasks are managed by the scheduler unit 510 and dispatched to a general processing cluster 518 by the work distribution unit 512. The general processing cluster 518 is configured to process the task and generate results. The results may be consumed by other tasks within the general processing cluster 518, routed to a different general processing cluster 518 via the crossbar 516, or stored in the memory 502. The results can be written to the memory 502 via the memory partition unit 520 modules, which implement a memory interface for reading and writing data to/from the memory 502. The results can be transmitted to another parallel processing unit 504 or CPU via the NVLink 522. In an embodiment, the parallel processing unit 504 includes a number U of memory partition unit 520 modules that is equal to the number of separate and distinct memory 502 devices coupled to the parallel processing unit 504. A memory partition unit 520 will be described in more detail below in conjunction with FIG. 7.

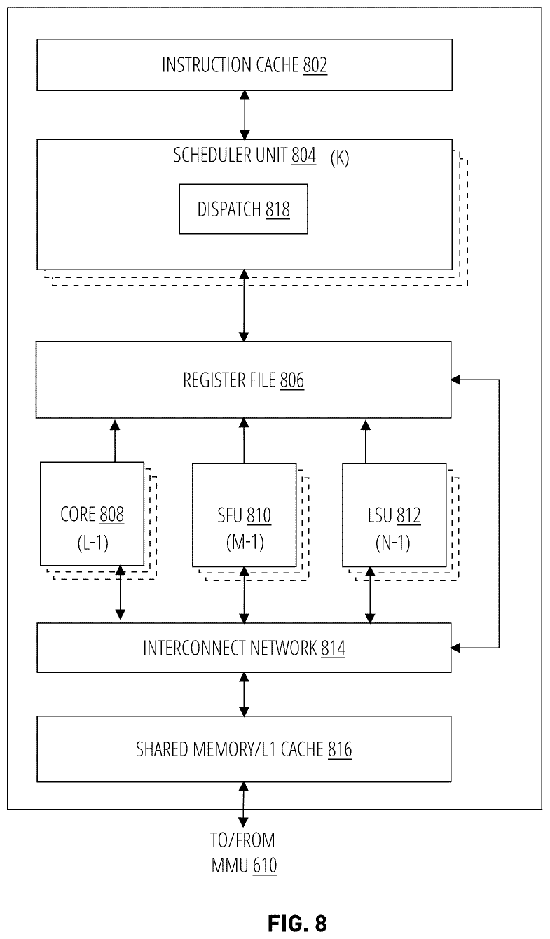

In an embodiment, a host processor executes a driver kernel that implements an application programming interface (API) that enables one or more applications executing on the host processor to schedule operations for execution on the parallel processing unit 504. In an embodiment, multiple compute applications are simultaneously executed by the parallel processing unit 504 and the parallel processing unit 504 provides isolation, quality of service (QoS), and independent address spaces for the multiple compute applications. An application may generate instructions (e.g., API calls) that cause the driver kernel to generate one or more tasks for execution by the parallel processing unit 504. The driver kernel outputs tasks to one or more streams being processed by the parallel processing unit 504. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

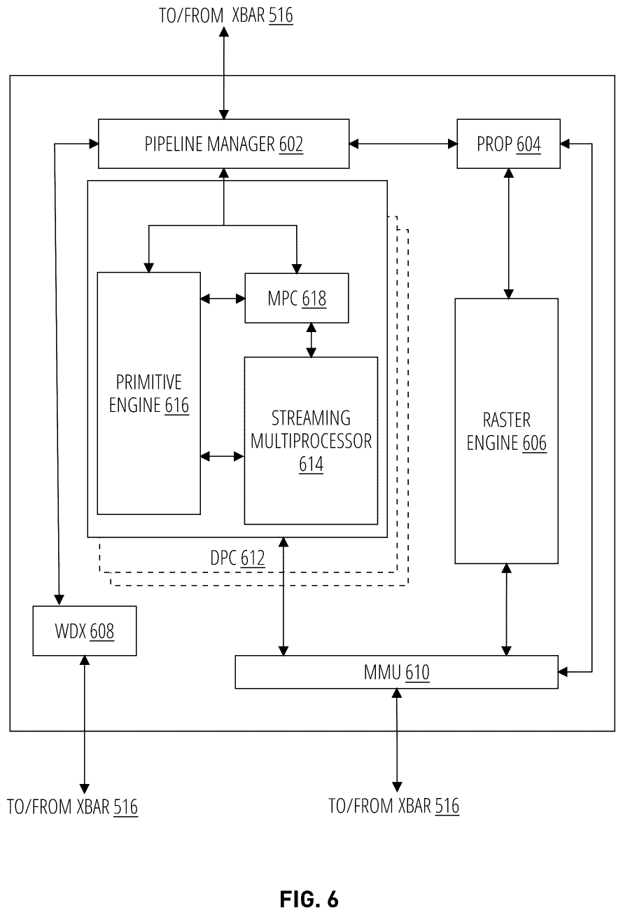

FIG. 6 depicts a general processing cluster 518 of the parallel processing unit 504 of FIG. 5, in accordance with an embodiment. As shown in FIG. 6, each general processing cluster 518 includes a number of hardware units for processing tasks. In an embodiment, each general processing cluster 518 includes a pipeline manager 602, a pre-raster operations unit 604, a raster engine 606, a work distribution crossbar 608, a memory management unit 610, and one or more data processing cluster 612. It will be appreciated that the general processing cluster 518 of FIG. 6 may include other hardware units in lieu of or in addition to the units shown in FIG. 6.

In an embodiment, the operation of the general processing cluster 518 is controlled by the pipeline manager 602. The pipeline manager 602 manages the configuration of the one or more data processing cluster 612 modules for processing tasks allocated to the general processing cluster 518. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 614. The pipeline manager 602 may also be configured to route packets received from the work distribution unit 512 to the appropriate logical units within the general processing cluster 518. For example, some packets may be routed to fixed function hardware units in the pre-raster operations unit 604 and/or raster engine 606 while other packets may be routed to the data processing cluster 612 modules for processing by the primitive engine 616 or the streaming multiprocessor 614. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 518 includes an M-pipe controller 618, a primitive engine 616, and one or more streaming multiprocessor 614 modules. The M-pipe controller 618 controls the operation of the data processing cluster 612, routing packets received from the pipeline manager 602 to the appropriate units in the data processing cluster 612. For example, packets associated with a vertex may be routed to the primitive engine 616, which is configured to fetch vertex attributes associated with the vertex from the memory 502. In contrast, packets associated with a shader program may be transmitted to the streaming multiprocessor 614.

The streaming multiprocessor 614 comprises a programmable streaming processor that is configured to process tasks represented by a number of threads. Each streaming multiprocessor 614 is multi-threaded and configured to execute a plurality of threads (e.g., 32 threads) from a particular group of threads concurrently. In an embodiment, the streaming multiprocessor 614 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 614 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 614 will be described in more detail below in conjunction with FIG. 8.

The memory management unit 610 provides an interface between the general processing cluster 518 and the memory partition unit 520. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 502.

FIG. 7 depicts a memory partition unit 520 of the parallel processing unit 504 of FIG. 5, in accordance with an embodiment. As shown in FIG. 7, the memory partition unit 520 includes a raster operations unit 702, a level two cache 704, and a memory interface 706. The memory interface 706 is coupled to the memory 502. Memory interface 706 may implement 32, 64, 128, 1024-bit data buses, or the like, for high-speed data transfer. In an embodiment, the parallel processing unit 504 incorporates U memory interface 706 modules, one memory interface 706 per pair of memory partition unit 520 modules, where each pair of memory partition unit 520 modules is connected to a corresponding memory 502 device. For example, parallel processing unit 504 may be connected to up to Y memory 502 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 504, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 502 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 504 modules process very large datasets and/or run applications for extended periods.

In an embodiment, the parallel processing unit 504 implements a multi-level memory hierarchy. In an embodiment, the memory partition unit 520 supports a unified memory to provide a single unified virtual address space for CPU and parallel processing unit 504 memory, enabling data sharing between virtual memory systems. In an embodiment the frequency of accesses by a parallel processing unit 504 to memory located on other processors is traced to ensure that memory pages are moved to the physical memory of the parallel processing unit 504 that is accessing the pages more frequently. In an embodiment, the NVLink 522 supports address translation services allowing the parallel processing unit 504 to directly access a CPU's page tables and providing full access to CPU memory by the parallel processing unit 504.

In an embodiment, copy engines transfer data between multiple parallel processing unit 504 modules or between parallel processing unit 504 modules and CPUs. The copy engines can generate page faults for addresses that are not mapped into the page tables. The memory partition unit 520 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 502 or other system memory may be fetched by the memory partition unit 520 and stored in the level two cache 704, which is located on-chip and is shared between the various general processing cluster 518 modules. As shown, each memory partition unit 520 includes a portion of the level two cache 704 associated with a corresponding memory 502 device. Lower level caches may then be implemented in various units within the general processing cluster 518 modules. For example, each of the streaming multiprocessor 614 modules may implement an L1 cache. The L1 cache is private memory that is dedicated to a particular streaming multiprocessor 614. Data from the level two cache 704 may be fetched and stored in each of the L1 caches for processing in the functional units of the streaming multiprocessor 614 modules. The level two cache 704 is coupled to the memory interface 706 and the crossbar 516.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 520 modules may be different than the number of general processing cluster 518 modules and, therefore, each raster operations unit 702 may be coupled to each of the general processing cluster 518 modules. The raster operations unit 702 tracks packets received from the different general processing cluster 518 modules and determines which general processing cluster 1 that a result generated by the raster operations unit 702 is routed to through the crossbar 516. Although the raster operations unit 702 is included within the memory partition unit 520 in FIG. 7, in other embodiment, the raster operations unit 702 may be outside of the memory partition unit 520. For example, the raster operations unit 702 may reside in the general processing cluster 518 or another unit.

FIG. 8 illustrates the streaming multiprocessor 614 of FIG. 6, in accordance with an embodiment. As shown in FIG. 8, the streaming multiprocessor 614 includes an instruction cache 802, one or more scheduler unit 804 modules (e.g., such as scheduler unit 510), a register file 806, one or more processing core 808 modules, one or more special function unit 810 modules, one or more load/store unit 812 modules, an interconnect network 814, and a shared memory/L1 cache 816.

As described above, the work distribution unit 512 dispatches tasks for execution on the general processing cluster 518 modules of the parallel processing unit 504. The tasks are allocated to a particular data processing cluster 612 within a general processing cluster 518 and, if the task is associated with a shader program, the task may be allocated to a streaming multiprocessor 614. The scheduler unit 510 receives the tasks from the work distribution unit 512 and manages instruction scheduling for one or more thread blocks assigned to the streaming multiprocessor 614. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 614 includes a register file 806 that provides a set of registers for the functional units of the streaming multiprocessor 614. In an embodiment, the register file 806 is divided between each of the functional units such that each functional unit is allocated a dedicated portion of the register file 806. In another embodiment, the register file 806 is divided between the different warps being executed by the streaming multiprocessor 614. The register file 806 provides temporary storage for operands connected to the data paths of the functional units.

Each streaming multiprocessor 614 comprises L processing core 808 modules. In an embodiment, the streaming multiprocessor 614 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 614 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 502 and sample the texture maps to produce sampled texture values for use in shader programs executed by the streaming multiprocessor 614. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 614 includes two texture units.

Each streaming multiprocessor 614 also comprises N load/store unit 812 modules that implement load and store operations between the shared memory/L1 cache 816 and the register file 806. Each streaming multiprocessor 614 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 614 and the primitive engine 616 and between threads in the streaming multiprocessor 614. In an embodiment, the shared memory/L1 cache 816 comprises 128KB of storage capacity and is in the path from the streaming multiprocessor 614 to the memory partition unit 520. The shared memory/L1 cache 816 can be used to cache reads and writes. One or more of the shared memory/L1 cache 816, level two cache 704, and memory 502 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 512 assigns and distributes blocks of threads directly to the data processing cluster 612 modules. The threads in a block execute the same program, using a unique thread ID in the calculation to ensure each thread generates unique results, using the streaming multiprocessor 614 to execute the program and perform calculations, shared memory/L1 cache 816 to communicate between threads, and the load/store unit 812 to read and write global memory through the shared memory/L1 cache 816 and the memory partition unit 520. When configured for general purpose parallel computation, the streaming multiprocessor 614 can also write commands that the scheduler unit 510 can use to launch new work on the data processing cluster 612 modules.

The parallel processing unit 504 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 504 is embodied on a single semiconductor substrate. In another embodiment, the parallel processing unit 504 is included in a system-on-a-chip (SoC) along with one or more other devices such as additional parallel processing unit 504 modules, the memory 502, a reduced instruction set computer (RISC) CPU, a memory management unit (MMU), a digital-to-analog converter (DAC), and the like.

In an embodiment, the parallel processing unit 504 may be included on a graphics card that includes one or more memory devices. The graphics card may be configured to interface with a PCIe slot on a motherboard of a desktop computer. In yet another embodiment, the parallel processing unit 504 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 504 of FIG. 5, in accordance with an embodiment. The processing system includes a central processing unit 902, a switch 904, and multiple parallel processing unit 504 modules each and respective memory 502 modules. The switch 904 is depicted with dashed lines, indicating that it is optional in some embodiments.

The NVLink 522 provides high-speed communication links between each of the parallel processing unit 504 modules. Although a particular number of NVLink 522 and interconnect 524 connections are illustrated in FIG. 9, the number of connections to each parallel processing unit 504 and the central processing unit 902 may vary. The switch 904 interfaces between the interconnect 524 and the central processing unit 902. The parallel processing unit 504 modules, memory 502 modules, and NVLink 522 connections may be situated on a single semiconductor platform to form a parallel processing module 906. In an embodiment, the switch 904 supports two or more protocols to interface between various different connections and/or links.

In another embodiment (not shown), the NVLink 522 provides one or more high-speed communication links between each of the parallel processing unit modules (parallel processing unit 504, parallel processing unit 504, parallel processing unit 504, and parallel processing unit 504) and the central processing unit 902 and the switch 904 (when present) interfaces between the interconnect 524 and each of the parallel processing unit modules. The parallel processing unit modules, memory 502 modules, and interconnect 524 may be situated on a single semiconductor platform to form a parallel processing module 906. In yet another embodiment (not shown), the interconnect 524 provides one or more communication links between each of the parallel processing unit modules and the central processing unit 902 and the switch 904 interfaces between each of the parallel processing unit modules using the NVLink 522 to provide one or more high-speed communication links between the parallel processing unit modules. In another embodiment (not shown), the NVLink 522 provides one or more high-speed communication links between the parallel processing unit modules and the central processing unit 902 through the switch 904. In yet another embodiment (not shown), the interconnect 524 provides one or more communication links between each of the parallel processing unit modules directly. One or more of the NVLink 522 high-speed communication links may be implemented as a physical NVLink interconnect or either an on-chip or on-die interconnect using the same protocol as the NVLink 522.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 502 modules may be packaged devices. In an embodiment, the central processing unit 902, switch 904, and the parallel processing module 906 are situated on a single semiconductor platform.

In an embodiment, each parallel processing unit module includes six NVLink 522 interfaces (as shown in FIG. 9, five NVLink 522 interfaces are included for each parallel processing unit module). The NVLink 522 may be operated exclusively for PPU-to-PPU communication as shown in FIG. 9, or some combination of PPU-to-PPU and PPU-to-CPU, when the central processing unit 902 also includes one or more NVLink 522 interfaces.

In an embodiment, the NVLink 522 allows direct load/store/atomic access from the central processing unit 902 to each parallel processing unit module's memory 502. In an embodiment, the NVLink 522 supports coherency operations, allowing data read from the memory 502 modules to be stored in the cache hierarchy of the central processing unit 902, reducing cache access latency for the central processing unit 902. In an embodiment, the NVLink 522 includes support for Address Translation Services (ATS), enabling the parallel processing unit module to directly access page tables within the central processing unit 902. One or more of the NVLink 522 may also be configured to operate in a low-power mode.

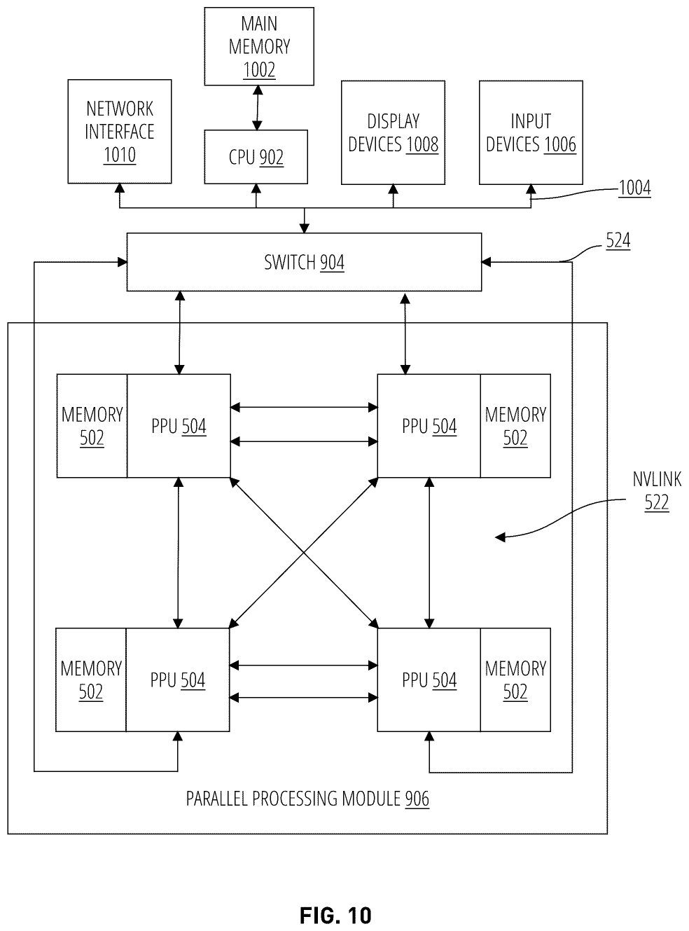

FIG. 10 depicts an exemplary processing system in which the various architecture and/or functionality of the various previous embodiments may be implemented. As shown, an exemplary processing system is provided including at least one central processing unit 902 that is connected to a communications bus 1004. The communication communications bus 1004 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1002. Control logic (software) and data are stored in the main memory 1002 which may take the form of random access memory (RAM). For simplicity of illustration, the main memory 1002 may be understood to comprise other forms of bulk memory, including non-volatile memory technologies.

The exemplary processing system also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1002 and/or the secondary storage. Such computer programs, when executed, enable the exemplary processing system to perform various functions. The main memory 1002, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### EXAMPLE QUESTIONS

Spatial localization question: Is the pot above the gas range?

Spatial localization question: Is the door left of the bookshelf?

Spatial compatibility question: Can the pot fit left of the stove?

Spatial localization question: Is the bag in front of the desk?

Spatial compatibility question: Can the bag fit on top of the bed?

Spatial localization question: Is the book above the bed?

Spatial compatibility question: Can the book fit on top of the bed?

Spatial localization questions: Return a point that is right of the window.

### LISTING OF DRAWING ELEMENTS

102 robotic system
104 boxed food item
106 container
202 point
204 object
402 vision-language model
404 image
406 question-and-answer
408 training dataset
410 scene
412 anchor object
414 object
416 natural language prompt
418 pick-and-place step
420 robotic task environment
422 3D bounding box annotation
424 camera pose
426 facing direction
428 floor plane
430 grid structure
432 segmentation model
434 image
436 camera
438 robot
502 memory
504 parallel processing unit
506 I/O unit
508 front-end unit
510 scheduler unit
512 work distribution unit
514 hub
516 crossbar
518 general processing cluster
520 memory partition unit
522 NVLink
524 interconnect
602 pipeline manager
604 pre-raster operations unit
606 raster engine
608 work distribution crossbar
610 memory management unit
612 data processing cluster
614 streaming multiprocessor
616 primitive engine
618 M-pipe controller
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 central processing unit
904 switch
906 parallel processing module
1002 main memory
1004 communications bus
1006 input devices
1008 display devices
1010 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to”perform that function after programming.

Reciting in the appended claims that a structure is “configured to” perform one or more tasks is expressly intended not to invoke 35 U.S.C. § 112(f) for that claim element.

Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system comprising:
a vision-language model configured with a training dataset comprising images labeled with spatial question-and-answer pairs;
the question-and-answer pairs encoding object-to-object relationships and object-to-space relationships depicted in the images; and
at least one data processor configured to operate the vision-language model to carry out a robotic task.

2. The system of claim 1, wherein the images comprise multiple reference frames.

3. The system of claim 1, wherein the training dataset further comprises reference frame codes.

4. The system of claim 1, wherein the question-and-answer pairs encode from among six spatial relationships.

5. The system of claim 4, wherein the spatial relationships comprise “left”, “right”, “in front”, “behind”, “above”, and “below”.

6. The system of claim 1, further comprising logic to generate content of the question-and-answer pairs from three dimensional (3D) bounding box annotations to the images.

7. The system of claim 6, wherein the 3D bounding box annotation comprise an orientation setting.

8. The system of claim 7, wherein the orientation setting comprises a rotation matrix.

9. The system of claim 6, wherein questions of the question-and-answer pairs encode object-to-object relationships for objects depicted in the images.

10. The system of claim 6, wherein questions of the question-and-answer pairs encode object-to-space relationships for objects depicted in the images.

11. The system of claim 6, further comprising logic to project the 3D bounding box onto a plane.

12. The system of claim 11, further comprising logic to mark a grid structure imposed on the plane with areas occupied by objects corresponding to the projected 3D bounding box.

13. The system of claim 1, wherein answers of the question-and-answer pairs encode true responses to questions of the question-and-answer pairs for tuning hyperparameters of the vision-language model during training.

14. The system of claim 13, wherein some of the answers are numeric.

15. The system of claim 14, wherein numeric answers are configured to ground the vision-language model in a reference frame.

16. The system of claim 1, wherein at least some of the question-and-answer pairs are configured in an ego-centric reference frame.

17. The system of claim 1, wherein at least some of the question-and-answer pairs are configured in an object-centric reference frame.

18. The system of claim 1, wherein at least some of the question-and-answer pairs are configured in an allo-centric reference frame.

19. The system of claim 1, wherein the object-to-object relationships and object-to-space relationships are encoded as (Iᵢ, aᵢ, tᵢ, sᵢ, rᵢ, lᵢ), where Iᵢ is an image, aᵢ is an anchor object, tᵢ is a target object or a target free-space point, sᵢ is size measure based on an object to be manipulated in the robotic system, rᵢ∈{left, right, above, below, front, behind} is a spatial relationship, and lᵢ∈{allo-centric, object-centric, ego-centric} is a reference frame label.

20. The system of claim 1, further comprising logic to generate a map of a robotic task environment, the map generated from the annotated 3D bounding box and randomly sampled points in empty areas that are a set distance from an object of the robotic task.

21. The system of claim 20, the set distance based on a size of another object that is to be manipulated and placed in relation to the object in the robotic task.

22. A system comprising:
a robot;
a vision-language model configured with a training dataset comprising images labeled with spatial question-and-answer pairs encoding object-to-object relationships and object-to-space relationships represented in the images; and
logic to operate the vision-language model to generate pick-and-place steps for the robot based on a natural language prompt.

23. The system of claim 22, the vision-language model further configured to decompose the natural language prompt into a series of the pick-and-place steps for an object depicted in a scene.

24. The system of claim 23, wherein each pick-and-place step is parameterized by a two-dimensional coordinate.

25. The system of claim 23, further comprising a segmentation model configured to segment objects depicted in the scene.

26. The system of claim 22, the vision-language model further configured to identify objects in its environment that are reasonable for the robot to manipulate.
